(19) United States
(12) Patent Application Publication
(10) Pub. No.: US 2026/0168830 A1
(43) Pub. Date: Jun. 18, 2026

(54) AN ELECTROMAGNETIC TRANSDUCER INTENDED TO MEASURE THREE-DIMENSIONAL VELOCITIES OF A FLOW OF AN ELECTRICALLY CONDUCTIVE FLUID

(71) Applicant: COMMISSARIAT A L'ENERGIE ATOMIQUE ET AUX ENERGIES ALTERNATIVES, Paris (FR)

(72) Inventor: Frederic REY, SAINT PAUL LEZ DURANCE (FR)

(21) Appl. No.: 18/975,870

(22) Filed: Dec. 10, 2024

(30) Foreign Application Priority Data
Dec. 19, 2023 (FR) 2314455

(51) Int. Cl. G01F 1/66; G01F 1/58

(52) U.S. Cl. CPC G01F 1/662; G01F 1/584; G01F 1/588

(57) ABSTRACT

An electromagnetic transducer intended to measure three-dimensional velocity components of a flow of an electrically conductive fluid. An electromagnetic transducer intended to measure the three-dimensional velocity components of a flow of an electrically conductive fluid, including a cylindrical metal tube forming a core with high magnetic permeability, which tube extends along a central axis (Z), comprising a central portion and two end portions, on either side of the central portion, each including three bosses, arranged at 120° relative to one another about the central axis (Z) and each delimiting a flat surface, parallel to the central axis (Z); an electrical coil (12), called primary coil, wound around the central portion of the tube; six electrical coils, called receiver coils, each wound around one of the flat surfaces, or six Hall effect sensors, each arranged on one of the flat surfaces.

### TECHNICAL FIELD

The present invention relates to the field of instrumentation and measurement, and more specifically to that of transducers dedicated to the local, point velocimetry of electrically conductive fluids, in particular in the field of three-dimensional point velocimetry in these fluids.

The invention relates to an electromagnetic transducer for measuring the velocity components of an electrically conductive fluid.

The invention is generally applicable to any electrically conductive fluid. Examples of such fluids are electrically conductive ionic solutions, such as salt water and, even more so, liquid metals. Typical examples of such metals are sodium, potassium, lead, lithium, aluminum, copper, iron, zinc, titanium and alloys thereof.

More specifically, the invention applies to measurements in dense liquid-type fluids with a density in a range of the order of 100 kg·m⁻³ to more than 10,000 kg·m⁻³.

The invention is particularly suitable for measuring the velocities of fluids whose melting temperature range is the melting temperature range of metals that are processed, shaped or used in liquid form, typically from approximately −50° C. to over 1,500° C.

One contemplated advantageous application is measuring heat-transfer fluid velocities, notably in nuclear fission and fusion reactors.

### BACKGROUND

In many applications, the velocity field of a moving electrically conductive fluid needs to be known.

This is the case in the metal foundry industry, where knowledge of the velocity field in foundry molds and their supply circuits allows the quality of the produced parts to be predicted and any rejects to be limited. Indeed, knowing flow velocities allows the filling of foundry molds to be controlled and optimized.

In the nuclear industry, the velocity field of the metal heat-transfer fluids used in the circuits of some nuclear reactors is a major factor in terms of the stress on contacting metal structures. For this reason, knowledge of the velocity field is essential.

It is also a major factor in terms of heat exchanges that exist in heat exchangers and in the nuclear fuel of these reactors. Knowledge and analysis of the velocity field in key areas of a reactor (heat exchangers, core outlet, pump, etc.) is also an indicator of correct operation and therefore a means of increasing safety and, in general, the possibilities for monitoring these machines.

Scientific experiments involving liquid metals in large volumes, and tests conducted with a view to knowing flow distributions in heat exchanger headers, also require knowledge of the velocity field of the flows that are involved.

In the various cited flow zones, the flow conditions are three-dimensional. Most often these flows are also characterized by their temperature level, most often several hundred degrees, and the density of the fluids that are used, which can range from a few hundred kg·m⁻³ to several thousand kg·m⁻³.

Various velocimetry techniques are known and used to measure the velocity components of a flow of electrically conductive liquid.

These techniques include electromagnetic techniques, which are particularly relevant and reliable, in terms of the resistance of the materials to the stresses applied thereto by the environment in which the measurement is to be carried out. These techniques are even more interesting in the case of dense, chemically reactive fluids, such as liquid metals.

The operating principle of electromagnetic transducers is illustrated by the expression of Ohm's law in a moving fluid subjected to a magnetic field.

It shows that the conductivity σ of the fluid leads to the development of currents (electric current density J) under the action of the velocity of movement u combined with the external magnetic field B:

$$\vec{{J}_{u}} = σ ( \vec{E} + \vec{u} \times \vec{B} ) \qquad [ Equation 1 ]$$

This occurs even in the absence of an electric field E.

The current densities Ju are the source of a magnetic field Bu. This field Bu distorts the external field B.

For the sake of simplicity, it should be noted that the vector symbolized by the letter B, which is the magnetic flux density or magnetic induction, is referred to throughout the application as the magnetic field. It also should be noted that the various formulations provided hereafter are written within the context of the quasi-permanent approximation of the regimes, allowing certain quantities involved in Maxwell's equations, such as displacement currents, to be disregarded.

To date, the measurements of a single velocity component of a flow are commonly carried out by electromagnetic transducers, commonly known by the acronym FDFM (“Flux Distortion Flow Meter”), ECFM (“Eddy Current Flow Meter”) or PSFM (“Phase Shift Flow Meter”).

A conventional FDFM, generally designated using reference sign 1, is shown in FIGS. 1, 2 and 2A: it is axisymmetric with a central axis X and is typically made up of a core 2, an electrical transmitting coil, called primary coil 3, and one or two electrical receiver coils, called secondary coils 4, 5. The core 2 is formed by a solid rod 20 extending along the central axis X and by solid discs 21 evenly spaced apart along the central axis X, with the solid rod connecting the solid discs together. The primary 3 and secondary 4, 5 coils are wound around the solid rod 20 between two of the solid discs 21.

An electric current is applied in the primary coil. The flow of this current creates an external magnetic field B in the immediate environment of the primary coil, according to the Maxwell-Ampere equation:

$$\vec{∇} \times \vec{B} = μ \cdot \vec{J} \qquad [ Equation 2 ]$$

with:
\vec{∇}: being the differential operator;
μ: being the magnetic permeability with μ=μᵣμ₀;
μ₀: being the magnetic permeability of the vacuum;
B: passing through the receiver coils.

The primary current is an alternating current, so that Bis also alternating. In this way, B induces an electrical voltage in each of the receiver coils, according to the Maxwell-Faraday equation:

$$\vec{∇} \times \vec{E} = - \frac{\partial \vec{B}}{\partial t} \qquad [ Equation 3 ]$$

with:
\vec{E}: being the electric field.

In addition, B also leads to the development of induced current densities Ji in the fluid, as well as in any surrounding electrical conductors subjected to this magnetic field, including the metal of the tubes. FIGS. 3 and 4 show the development of current densities induced under the action of the external magnetic field, in the absence of flow velocity, for an FDFM with one secondary coil 4 and two secondary coils 4, 5, respectively.

The current densities Ji in turn create a magnetic field Bi that distorts the external field B. Thus, the field B is not the same depending on whether or not the FDFM is surrounded by an electrically conductive fluid.

In the absence of fluid movement, the one or more receiver coils deliver electrical voltages that are functions of the external magnetic field B and of the field Bi.

In the presence of fluid movement, new current densities Ju appear and are the source of a magnetic field Bu. This new field modifies B, which is blown, as it were, by the flow of conductive fluid and distorts toward the flow of fluid, as illustrated in FIGS. 5A, 5B and 6.

The magnetic flux passing through the one or more receiver coils depends on the flow velocity.

The one or more receiver coils therefore deliver electrical voltages reflecting the influence of the magnetic fields Bi and Bu that distort the external field B.

This is illustrated by digital simulations. FIGS. 7A and 7B are digital simulations of the magnetic field around an FDFM in the absence and in the presence of a flow velocity of electrically conductive fluid, respectively.

By analyzing the electrical voltages delivered by the receiver coils, it is possible to determine the flow velocity of the moving fluid in the zone of action of the magnetic field B.

As shown in FIG. 8, if the single receiver coil 4 of an FDFM 1 is upstream with respect to the direction of the flow of fluid, it experiences a drop in magnetic flux as the velocity increases (and vice versa). The voltage e₁ it supplies decreases by Δₑ₁.

The voltage e₁ supplied by the FDFM is the image of the flow velocity (with an indication of the relative direction by comparing the amplitude of the current signal with the amplitude of the signal without velocity).

In addition to the above, in the case of an FDFM with two receiver coils, the downstream receiver coil experiences an increase in the flux passing through it as the fluid velocity increases. Its voltage e₂ increases by Δe₂.

Then |Δe₂|=|Δe₁|.

Generally, the two receiver coils 4, 5 of an FDFM are electrically coupled in an anti-series manner, as shown in FIG. 9.

In this way, the signal V supplied by the two-coil FDFM is provided by:

$$V = \vert {e}_{2} \vert - \vert {e}_{1} \vert .$$

with |eₓ|: being the modulus or amplitude of the voltage eₓ.

The signal V is proportional to the velocity component of the flow projected onto the axis of rotation of the FDFM.

In practice, the FDFM with two receiver coils is preferred, as the combined use of the voltages delivered by these two coils doubles the sensitivity and eliminates the dependence of the response of the FDFM on irrelevant quantities such as the temperature:

$$V = ( \vert {e}_{2} \vert - \vert {e}_{1} \vert ) / ( \vert {e}_{2} \vert + \vert {e}_{1} \vert ) .$$

The sign of V provides the direction of the velocity without having to compare with the amplitude of the signal without flow velocity.

With respect to the arrangement of the FDFMs relative to the flow of fluid, they can be inside the flow, i.e., positioned on the axis of a tube in the middle of the flow to be characterized: [1]. An FDFM is thus within the flow of fluid, which is peripheral to the FDFM.

In practice, as shown in FIG. 10, an internal FDFM 1 is generally placed in the center of an annular space, delimited by two concentric tubes T1, T2, in which the fluid F flows whose velocities are to be measured.

Other FDFMs can be outside the flow. The coils and the core of external FDFMs are thus arranged around the flow of fluid whose velocities are to be measured.

In practice, an external FDFM is placed around a tube in order to measure the velocity of the flow of fluid through the tube: [2].

When FDFMs are used to assess the velocity of a fluid flowing through a tube, whether they are inside or outside the tube, they can only measure one velocity component, namely, the component along the axis of the tube and therefore along their axis of axisymmetry X. Indeed, the tube guides the flow of fluid and provides it with its main direction.

In general, for a conventional FDFM placed in an open medium, i.e., in a large volume of moving electrically conductive fluid, i.e., in a volume whose boundaries are sufficiently far away from the FDFM for them not to orientate the velocity vector of the flow in the vicinity of the FDFM, it can be seen that the FDFMs can only take into account a single velocity component of the flow, which is that projected along the axis of axisymmetry of the FDFM. This is due to the axisymmetric constitution of an FDFM.

Consequently, the use of conventional FDFMs in an open environment is inconclusive for characterizing several velocity components where the FDFM is located. In particular, measuring the velocity of dense, electrically conductive fluids in open environments is a problem in itself.

The modelling and simulations of an FDFM according to the prior art in an open environment, subjected to different velocities of three-dimensional components, prove this.

The inventors have modelled an FDFM according to the prior art and its operation has been simulated for different velocity stresses surrounding the flow of a moving liquid metal (sodium). The analysis orthonormal coordinate system in which the velocities are expressed is x, y, z.

FIGS. 11 and 11A illustrate, for this FDFM according to the prior art that is subjected to a velocity component x, the magnetic flux density, the velocity vector, the normal section y and the normal section z.

FIGS. 12 and 12A illustrate, for the same FDFM according to the prior art subjected to a velocity component y, the magnetic flux density, the velocity vector, the normal section x and the normal section z.

Therefore, it can be seen that, when subjected to a velocity component field along x, an FDFM according to the prior art provides the same response signal as when it is subjected to a single velocity component field along y.

In conclusion, the internal or external FDFMs according to the prior art cannot be used to simultaneously measure several components of the multidimensional flow velocity of a fluid at a given point location.

The simultaneous use of several FDFMs, one per velocity component, for example, positioned and oriented so as to form a direct orthonormal coordinate system or any other arrangement, is not possible either because of the mutual interaction of the magnetic fields of the various FDFMs that are placed close to each other.

Furthermore, transducers capable of measuring several velocity components of a flow of fluid virtually at a single point are also known: [3], [4], [5].

These include wire or hot-film probes for aerodynamic measurements. These probes are fragile and therefore limited to use at velocities of a few millimeters per second at best.

Potential probes can be used to measure local velocities, potentially over several velocity components. However, their operation relies on electrical contact between their electrodes and the fluid to be characterized. They are also highly sensitive to oxidation, notably in liquid metals. Electrical insulation is also required between the electrodes and the metal structure of the probe for use with liquid metals. This restricts its use to lower fluid temperature ranges than contactless electromagnetic measurement technologies.

Thus, no measurement transducers exist that are capable of assessing multiple components of flow velocities of electrically conductive fluids, which can be dense, over a range of high velocities and/or at high temperatures.

Contactless induction tomography methods have already been tested for measuring multi-dimensional fluid flow velocities.

Publication [6] describes one such method, which is currently only capable of measuring two velocity components at points in a radial plane of the fluid. The ability to measure three velocity components has not been demonstrated.

Patent EP 1285277 B1 also describes a contactless induction tomography method.

The main constraint faced by contactless induction tomography methods is that the useful magnetic field to be observed is of the order of 2 to 5 orders of magnitude lower than that of the magnetic field that needs to be applied.

Furthermore, these methods also require working on relatively small volumes of fluid, typically of the order of 1 m, so that the external magnetic field can propagate throughout the volume to be characterized.

In addition, these methods require complex processing algorithms.

The external magnetic field must also pass through the material of the walls containing the moving fluid, because the equipment implementing the measurement method is placed outside. The performance capabilities of the method therefore depend on the nature of the wall material, its thickness and also the overall geometry of the tomography.

To summarize, FDFMs of the prior art are incapable of simultaneously measuring multiple velocity components. They cannot be combined together in close proximity to each other to measure several velocity components at a given location due to the disturbances that they transmit to each other.

Existing measurement transducers are not capable of assessing multiple velocity components of electrically conductive fluids, which can be dense, for a range of high velocities and/or at high temperatures.

Three-dimensional flow measurement methods using contactless tomography are comprehensive. They use equipment disposed outside the fluid volume to be characterized.

Their performance capabilities depend on the structures containing the volume of fluid. Their signals are difficult to process. The size of the volume of fluid that they can characterize must be limited. Thus, they cannot be implemented in a large volume, such as the inside of a sodium-cooled nuclear reactor vessel.

Therefore, a requirement exists to propose a solution for three-dimensional measurements of flow velocities of electrically conductive fluids, which can be dense, for a range of high velocities and/or at high temperatures, even in large volumes.

The aim of the invention is to at least partly address this requirement.

### DISCLOSURE OF THE INVENTION

To this end, according to a first alternative, the aim of the invention is an electromagnetic transducer intended to measure the three-dimensional velocity components of a flow of an electrically conductive fluid, comprising:
a cylindrical metal tube forming a core with high magnetic permeability, which tube extends along a central axis (Z), comprising a central portion and two end portions, on either side of the central portion, each comprising three bosses, arranged at 120° relative to one another about the central axis (Z) and each delimiting a flat surface, parallel to the central axis (Z);
an electrical coil, called primary coil, wound around the central portion of the tube;
six electrical coils, called receiver coils, each wound around one of the flat surfaces, or six Hall effect sensors, each arranged on one of the flat surfaces.

According to a second alternative, the subject matter of the invention is an electromagnetic transducer intended to measure the three-dimensional velocity components of a flow of electrically conductive fluid, comprising:
a cylindrical metal tube forming a core with high magnetic permeability, which tube extends along a central axis (Z), comprising a central portion and two end portions, on either side of the central portion, each comprising three bosses, arranged at 120° relative to one another about the central axis (Z) and each delimiting a flat surface, parallel to the central axis (Z);
a permanent magnet arranged around the central portion of the tube;
six electrical coils, called receiver coils, each wound around one of the flat surfaces, or six Hall effect sensors, each arranged on one of the flat surfaces.

Preferably, the core has low electrical conductivity in order to limit the losses induced by the variable magnetic induction, namely, the Joule losses associated with the circulation of the induced current and the hysteresis losses.

Thus, the invention mainly involves an electromagnetic transducer that can be operated with alternating current (first variant) or with direct current (second variant) for contactlessly measuring three three-dimensional components of an electrically conductive fluid.

The careful arrangement of the receiver coils or Hall effect sensors at 120° relative to each other allows the contribution of each of the components of the local velocity vector to be measured by electromagnetic flux distortion, without any disturbance from the other contributions.

A flux-distortion electromagnetic transducer according to the invention can measure velocities from a few millimeters per second to several meters per second.

In addition, it is adapted for measuring the velocities of electrically conductive liquids that are dense, typically with a density of the order of 100 to more than 10,000 kg·m⁻³, and/or are at a high temperature, typically in the range of the melting temperatures for metals that are processed, shaped or used in liquid form.

Ultimately, an electromagnetic transducer according to the proposed invention overcomes the limitations identified in the devices of the prior art and has many advantages, including:
the possibility of simultaneously measuring three velocity components of a flow of electrically conductive fluid in the volume of fluid in its immediate vicinity;
not having to combine it with other transducers of the same type, at the risk of rendering its measurements inoperative, as is the case with an FDFM of the prior art;
the possibility of positioning it within the flow to be characterized in the zone to be studied;
characterizing the velocity components of the flow, even in very large volumes of fluid;
processing the signals it produces, which is considerably less complex than the reconstruction algorithms required for tomographic measurement methods.

A further aim of the invention is the use of an electromagnetic transducer as described above for measuring the three-dimensional velocity components of a flow of an electrically conductive fluid, such as liquid metal in a nuclear reactor.

### BRIEF DESCRIPTION OF THE DRAWINGS

Further advantages and features will become more clearly apparent upon reading the detailed description, which is illustrative and non-limiting, with reference to the following figures:

FIG. 1 is a schematic side view of a Flux Distortion Flow Meter (FDFM) according to the prior art, with a (secondary) receiver coil;

FIG. 2 is a schematic side view of an FDFM of the prior art with two (secondary) receiver coils;

FIG. 2A is a longitudinal section view of FIG. 2;

FIG. 3 is taken from FIG. 1 and illustrates the development of induced current densities under the action of the external magnetic field in the absence of flow velocity;

FIG. 4 is taken from FIG. 2 and illustrates the development of induced current densities under the action of the external magnetic field in the absence of flow velocity;

FIGS. 5A and 5B are taken from FIG. 1 and illustrate the development of induced current densities under the action of the external magnetic field in the presence of a flow velocity;

FIG. 6 is taken from FIG. 2 and illustrates the development of induced current densities under the action of the external magnetic field in the presence of a flow velocity;

FIGS. 7A and 7B are representations of digital simulations of the magnetic field around an FDFM according to the prior art, respectively in the absence and in the presence of a flow velocity of electrically conductive fluid;

FIG. 8 is taken from FIG. 1 and illustrates the electrical voltage at the terminals of the receiver coil of the FDFM according to the prior art;

FIG. 9 is taken from FIG. 2 and illustrates a preferred electrical coupling of the receiver coils in an anti-series manner, as well as the electrical voltages at the terminals of the coils and the final voltage measured at the terminals of the FDFM according to the prior art;

FIG. 10 is a reprographic reproduction of an FDFM of the prior art as arranged inside an implantation tube for measuring a one-dimensional velocity of a flowing fluid F;

FIGS. 11 and 11A are representations of digital simulations, for an FDFM according to the prior art subjected to a velocity component X, of its magnetic flux density, of its velocity vector as a section of the normal Y and of the normal Z, respectively;

FIGS. 12 and 12A are representations of digital simulations, for an FDFM according to the prior art subjected to a velocity component Y, of its magnetic flux density, of its velocity vector as a section of the normal Y and of the normal Z, respectively;

FIG. 13 is a schematic perspective view of an electromagnetic transducer according to an alternative of the invention operating with alternating current and receiver coils;

FIG. 14 is a side view along the X-axis of the electromagnetic transducer according to FIG. 13;

FIG. 15 is a front view along the Z-axis of the electromagnetic transducer according to FIG. 13;

FIG. 16 is taken from the electromagnetic transducer according to FIG. 13, showing the measurement lines and planes;

FIGS. 17 and 17A are representations of digital simulations of the electromagnetic transducer according to FIG. 13 in the presence of an electrically conductive fluid without movement;

FIG. 18 is a representation of a digital simulation of an electromagnetic transducer according to FIG. 13 subjected to a velocity component Z;

FIGS. 19, 19A and 19B are representations of digital simulations of an electromagnetic transducer according to FIG. 13 subjected to a velocity component X;

FIG. 20 is a representation of a digital simulation of an electromagnetic transducer according to FIG. 13 subjected to a velocity component Y;

FIG. 21 is a schematic perspective and longitudinal section view of an electromagnetic transducer according to FIG. 13 showing the arrangement of the electrical connection wires for connecting to the primary and secondary coils;

FIG. 22 is a schematic perspective view of an electromagnetic transducer according to the invention with Hall effect sensors;

FIG. 23 is a side view along the X-axis of the electromagnetic transducer according to FIG. 22;

FIG. 24 is a side view along the Y-axis of the electromagnetic transducer according to FIG. 22;

FIG. 25 is a front view along the Z-axis of the electromagnetic transducer according to FIG. 22;

FIG. 26 is taken from the electromagnetic transducer according to FIG. 22, showing the measurement lines and planes;

FIG. 27 is a schematic perspective and longitudinal section view of an electromagnetic transducer according to FIG. 22 showing the arrangement of the electrical connection wires for connecting to the primary and secondary coils;

FIG. 28 is a schematic perspective view of an electromagnetic transducer according to an alternative of the invention with direct current operation, a permanent magnet and receiver coils;

FIG. 29 is a schematic perspective and longitudinal section view of an electromagnetic transducer according to FIG. 28 showing the arrangement of the electrical connection wires for connecting to the primary and secondary coils.

### DETAILED DESCRIPTION

Throughout the present application, the terms “upstream” and “downstream” are to be understood with reference to the direction of flow of a fluid around the transducer along the Z-axis.

Throughout the application, an electromagnetic transducer according to the invention is defined in a position relative to an XYZ orthogonal coordinate system forming a trihedron, comprising three axes that are perpendicular in pairs, namely:
an X-axis, defining a transverse direction;
a Y-axis, defining a transverse direction, which defines an XY plane with the X-axis;
a Z-axis, defining a longitudinal direction, perpendicular to the XY plane, and defining the general direction along which the transducer extends and the axis of rotation of the primary coil.

By convention, for the remainder of the description, the Y-axis is the axis normal to the upper face of two bosses on the same measurement line L1. A measurement line is defined as being the imaginary straight line parallel to the Z-axis and passing through the center of the upper faces of two bosses on the same normal.

The indices i used to geometrically define the transducer bosses and coils are those used for electromagnetic coupling and signal processing, as explained below.

The bosses and coils arranged on the same end portion of the transducer core all have either the same odd or even index. In the following simulations, the upstream end portion of the core supports the odd-index coils.

The voltages produced by the six receiver coils are denoted e1, e2, e3, e4, e5 and e6, respectively.

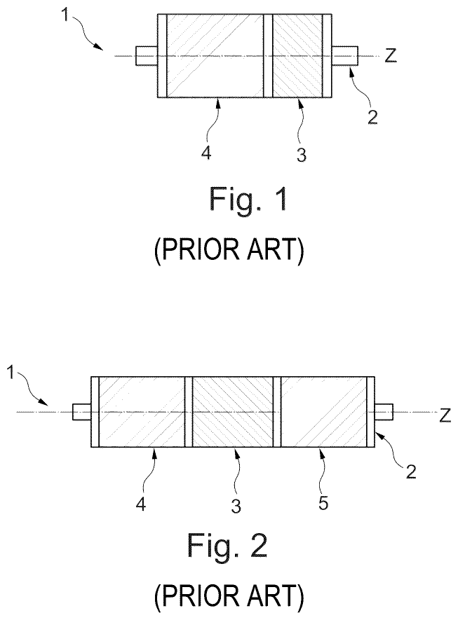

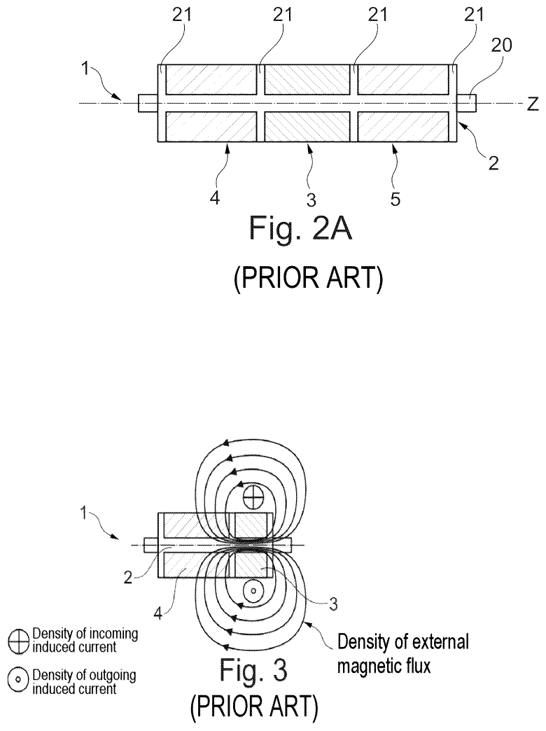

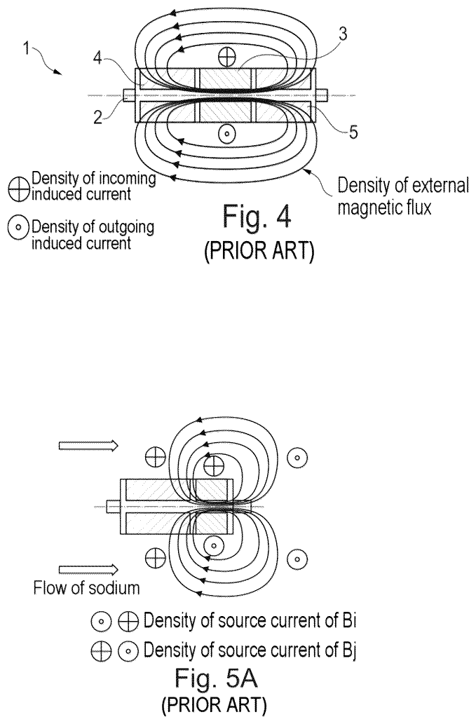

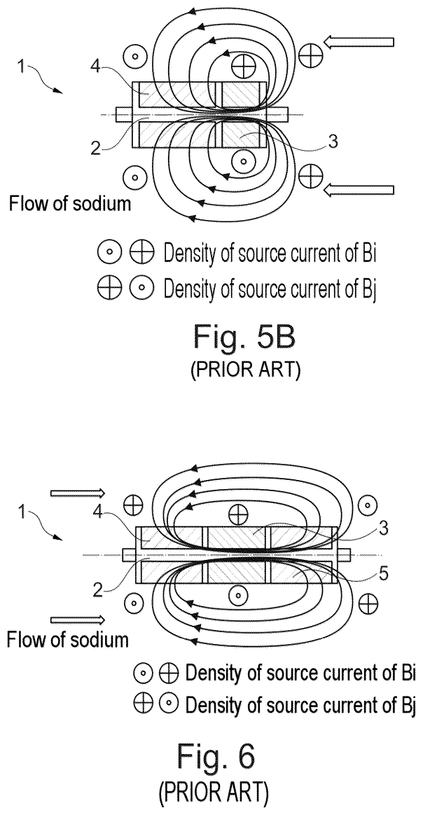

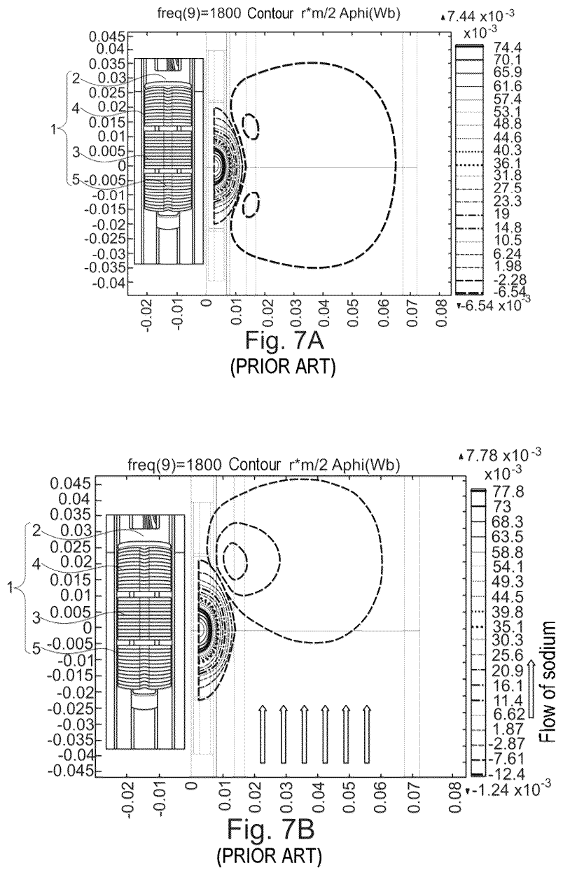

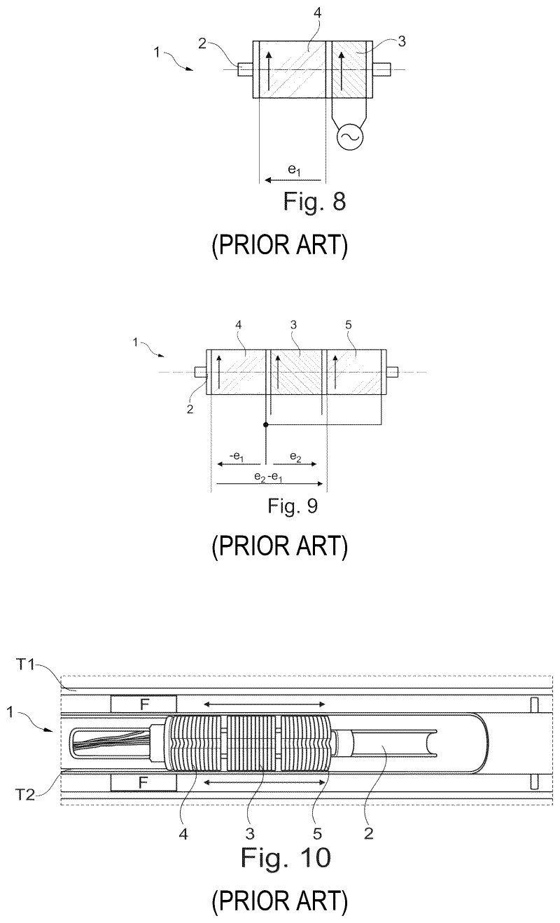

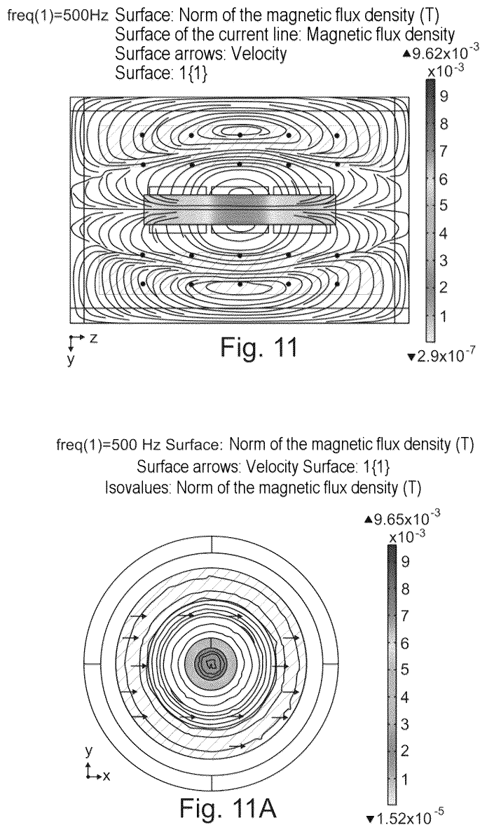

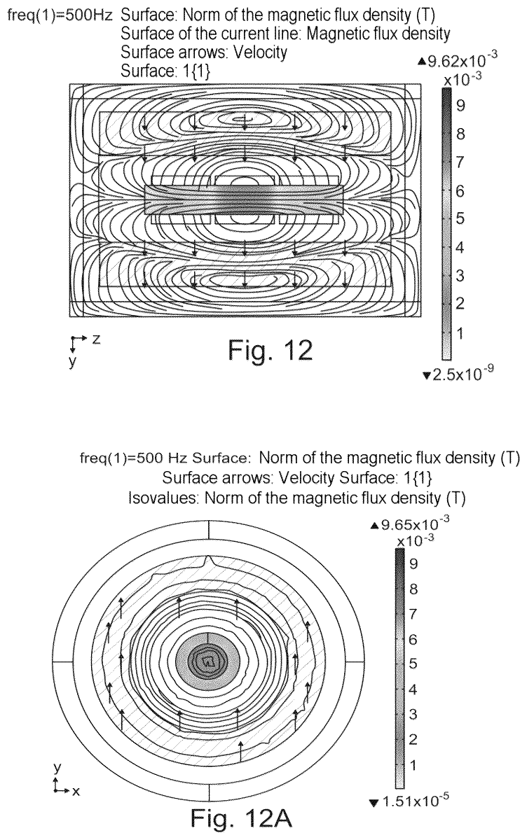

FIGS. 1 to 12A have already been described in the preamble. Therefore, they will not be described in detail hereafter.

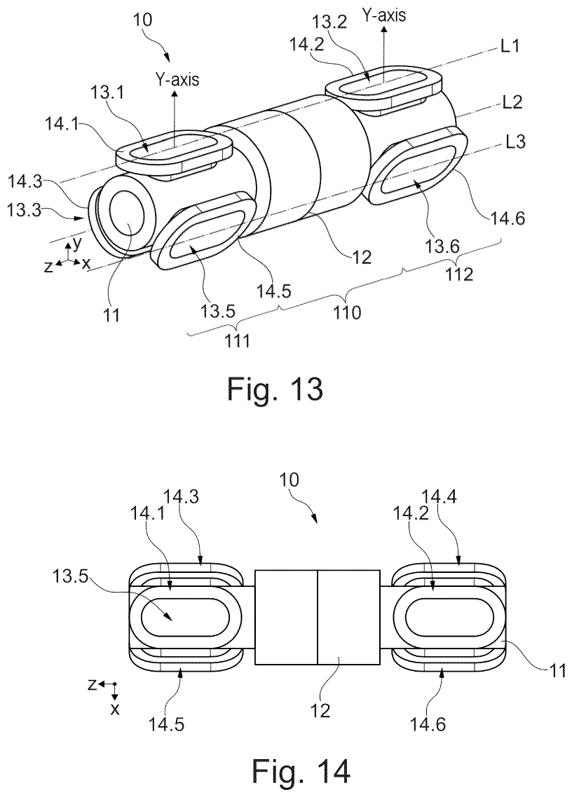

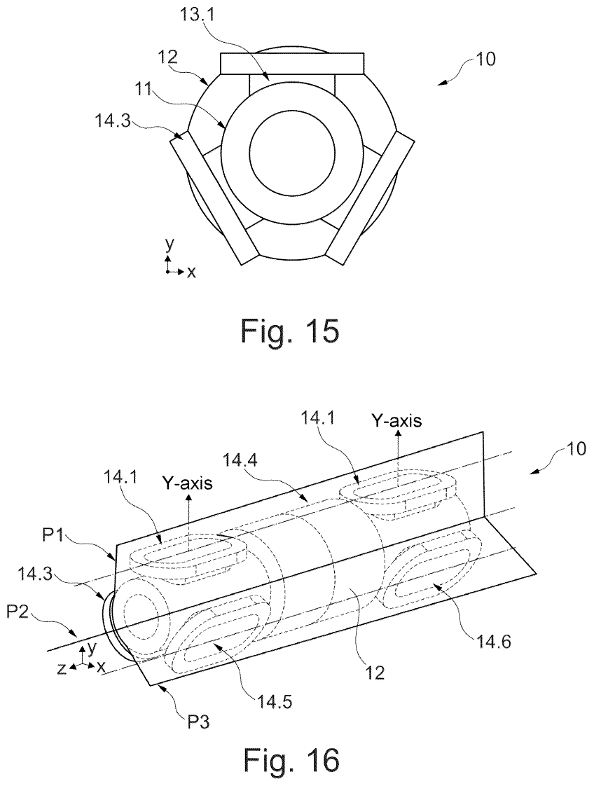

FIGS. 13 to 16 show an electromagnetic transducer 10 according to the invention that is intended to measure the three velocity components of a flow of an electrically conductive fluid.

This transducer 10 firstly comprises a cylindrical metal tube 11 forming an electromagnetic core, which extends along a central axis Z, comprising a central portion 110 and two end portions 111, 112, on either side of the central portion. Preferably, the length of the central portion 110 is equal to that of each of the two end portions 111, 112.

The upstream end portion 111 comprises three bosses 13.1, 13.3, 13.5 arranged at 120° relative to one another about the central axis (Z) and each delimiting a flat surface, parallel to the central axis (Z).

The downstream end portion 112 comprises three bosses 13.2, 13.4, 13.6 arranged at 120° relative to one another about the central axis (Z) and each delimiting a flat surface, parallel to the central axis (Z).

Preferably, all the bosses have identical sizes and shapes.

Advantageously, each boss is T-shaped as a front view, orthogonal to the central axis (Z), with the head of the T being the flat surface.

A primary electrical coil 12 is wound around the central portion 110 of the tube 11.

Six electrical receiver coils 14.1, 14.2, 14.3, 14.4, 14.5 and 14.6 are each wound around one of the flat surfaces of the bosses 13.1, 13.2, 13.3, 13.4, 13.5 and 13.6, respectively. The operation of the electromagnetic transducer 10 will now be explained in relation to the simulations carried out by the inventors.

As previously defined, the transducer 10 has three measurement lines: L1, L2, L3.

The primary coil 12 is supplied with alternating current.

This current creates an external magnetic field B that has three planes of symmetry P1, P2, P3 intersecting on the Z-axis. Each of these planes passes through one of the measurement lines L1, L2 and L3. Measurement plane P1 relates to the pair of coils 14.1 and 14.2. Measurement plane P2 relates to the pair of coils 14.3 and 14.4. Measurement plane P3 relates to the pair of coils 14.5 and 14.6.

For the sake of simplicity, the magnetic couplings are considered that exist between the primary coil 12 and, respectively, the pair of coils 14.1 and 14.2 of the measurement plane P1, the pair of coils 14.3 and 14.4 of the measurement plane P2 and the pair of coils 14.5 and 14.6 of the measurement plane P3.

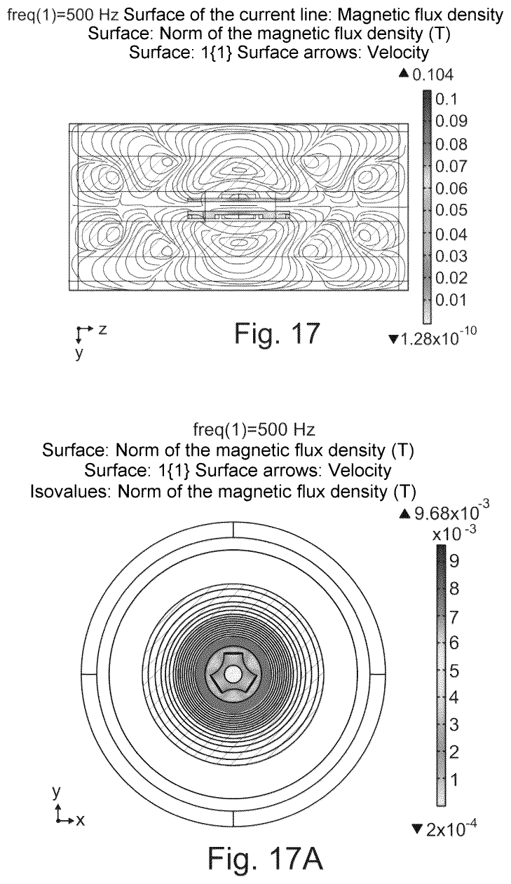

As can be seen in FIGS. 17 and 17A, a field Bi exists that modifies neither the symmetry of B nor the coupling between the primary coil 12 and the receiver or secondary coils.

A three-dimensional flow fluid surrounding the transducer 10 will modify the magnetic field coupling between the primary coil 12 and the six secondary coils 14.1, 14.2, 14.3, 14.4, 14.5, 14.6, by causing a field Bu to be created. This distortion can be measured by virtue of the induced voltages present on the receiver coils.

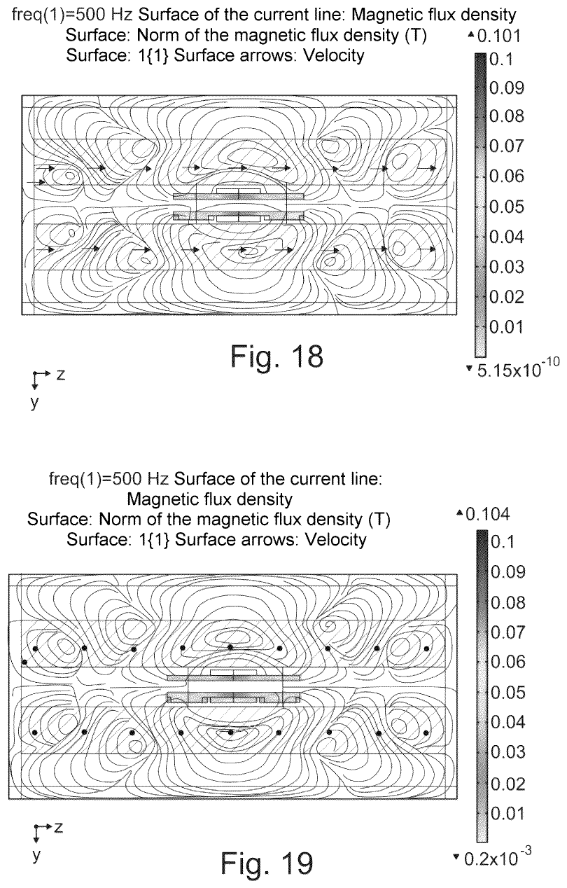

A movement of electrically conductive fluid around the transducer 10 with only a positive velocity component along the Z-axis similarly modifies the couplings of the pairs of coils in each of the three measurement planes P1, P2, P3. In other words, the receiver coils 14.1, 14.3, 14.5 have an induced voltage at their terminals that increases by Ae, while at the same time the coils 14.2, 14.4, 14.6 have an induced voltage at their terminals that decreases by Ae. This flux distortion under the action of a velocity flow along the Z-axis is shown in FIG. 18.

Signal processing of the same type as that applied to the coils of an FDFM according to the prior art, as explained in the preamble, is applicable to the pairs of coils 14.1, 14.2 and 14.3, 14.4 and 14.5, 14.6 for measuring the velocity component z. Thus, the voltage differences e₁−e₂=e₃−e₄=e₅−e₆ between the coils are linear functions of Z.

It is possible to determine the sum of these voltage differences (e₁−e₂)+ (e₃−e₄)+ (e₅−e₆) in order to increase the sensitivity of the transducer 10 relative to the measurement of a velocity component along Z.

A flow represented by a velocity vector contained in any plane passing through the Z-axis and not just having a single component on this axis, will distort the coupling between the primary coil 12 and, respectively, each of the coils of the groups in the end portions, namely, the group of coils 14.1, 14.2, 14.3 and the group of coils 14.4, 14.5, 14.6.

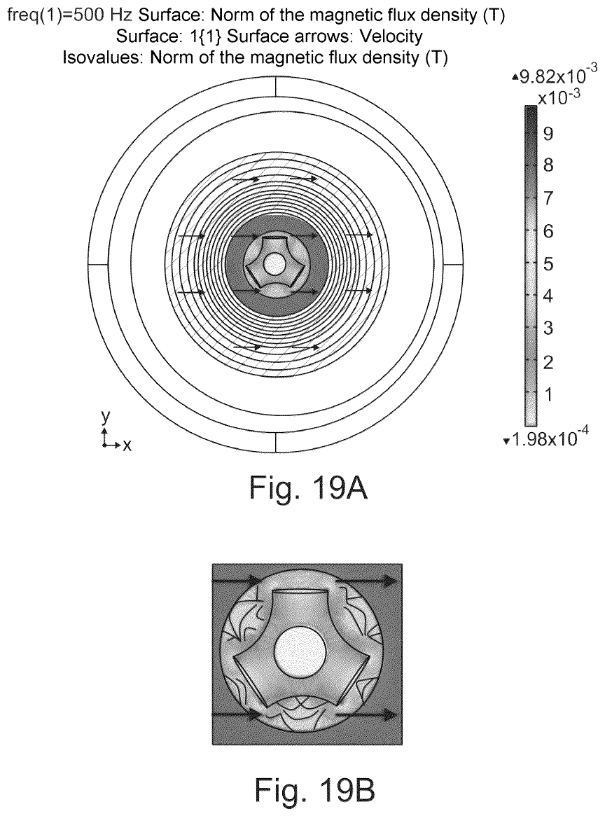

FIGS. 19, 19A, 19B thus illustrate a flux distortion under the action of a velocity flow along the X-axis.

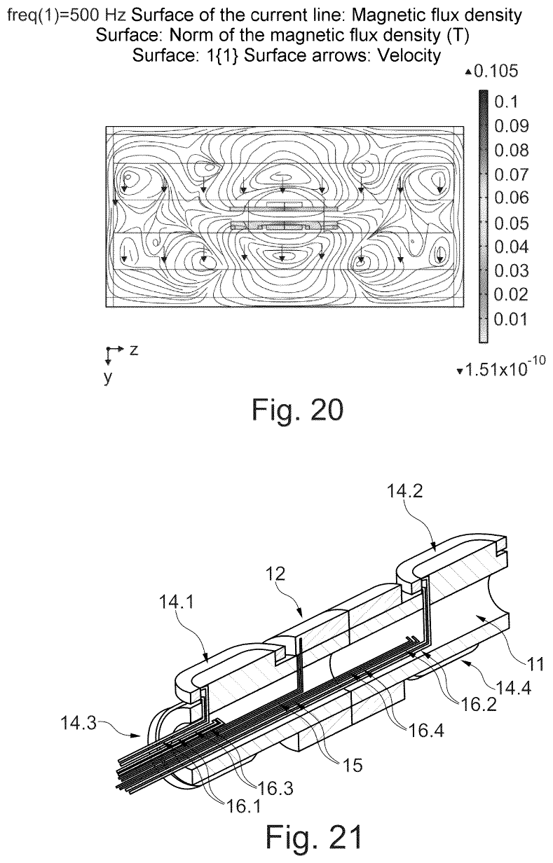

FIG. 20 for its part illustrates the flux distortion under the action of a velocity flow along the Y-axis.

Thus, any flow velocity with three-dimensional components can be characterized by a transducer 10 according to the invention.

In general, a matrix relationship can be defined in order to reflect the voltages produced by the six receiver coils 14.1 to 14.6, e₁, e₂, e₃, e₄, e₅, e₆, as three-dimensional components (Ux, Uy, Uz) of the local velocity vector U.

This matrix is expressed as follows:

$$[ \begin{matrix}Ux \\ Uy \\ Uz\end{matrix} ] = [ \begin{matrix}T 11 & T 12 & T 13 & T 14 & T 15 & T 16 \\ T 21 & T 22 & T 23 & T 24 & T 25 & T 26 \\ T 31 & T 32 & T 33 & T 34 & T 35 & T 36\end{matrix} ] \cdot [ \begin{matrix}e 1 \\ e 2 \\ e 3 \\ e 4 \\ e 5 \\ e 6\end{matrix} ]$$

$$Thus :$$

$$\begin{matrix}{U}_{x} = {T}_{11} . {e}_{1} + {T}_{12} . {e}_{2} + {T}_{13} . {e}_{3} + {T}_{14} . {e}_{4} + {T}_{15} . {e}_{5} + {T}_{16} . {e}_{6} \\ {U}_{y} = {T}_{21} . {e}_{1} + {T}_{22} . {e}_{2} + {T}_{23} . {e}_{3} + {T}_{24} . {e}_{4} + {T}_{25} . {e}_{5} + {T}_{26} . {e}_{6} \\ {U}_{z} = {T}_{31} . {e}_{1} + {T}_{32} . {e}_{2} + {T}_{33} . {e}_{3} + {T}_{34} . {e}_{4} + {T}_{35} . {e}_{5} + {T}_{36} . {e}_{6}\end{matrix}$$

Tᵢⱼ defines the contribution of eⱼ in the response of the transducer to a flow velocity present in the measurement plane i and, therefore, in the expression of the velocity component Ux.

Tᵢⱼ depends on the features of the transducer materials, firstly, the material forming the core 11, the geometry of the bosses 13.1 to 13.6 and the features of the receiver coils, including the number of turns of each of them.

Tᵢⱼ also reflects the properties of the electrically conductive fluid and the influence of temperature on the materials present.

Finally, Tᵢⱼ is also a function of the excitation applied to the transducer: the nature and the intensity of the magnetic excitation produced by the primary coil.

The following can be expressed: Tᵢⱼ=kₜ·kₑ·Kᵢⱼ, with
kₜ: being a temperature-related influence factor on the various materials present;
kₑ: being an excitation-related influence factor;
Kᵢⱼ: reflecting the influence of the constitution of the transducer.

Thus, the matrix of three-dimensional components (Ux, Uy, Uz) of the local velocity vector U can be expressed as follows:

$$[ \begin{matrix}U x \\ U y \\ U z\end{matrix} ] = {k}_{t .} {k}_{e .} [ \begin{matrix}K 11 & K 12 & K 13 & K 14 & K 15 & K 16 \\ K 21 & K 22 & K 23 & K 24 & K 25 & K 26 \\ K 31 & K 32 & K 33 & K 34 & K 35 & K 36\end{matrix} ] \cdot [ \begin{matrix}e 1 \\ e 2 \\ e 3 \\ e 4 \\ e 5 \\ e 6\end{matrix} ]$$

Normally, the features of an FDFM of the prior art, as described in the preamble, are established through the results of digital simulations or experimentation.

Reference can be made to publication [7], which describes a method for calibrating an external FDFM, by imposing a known volumetric flow rate Q of a liquid metal, in the implantation tube around which the FDFM is positioned. As the flow rate Q is imposed, the voltages S₁ and S₂ produced by the secondary coils 4 and 5 are measured and exploited so that the response A of the FDFM is defined by:

$$\begin{matrix}A = {A}_{1} / {A}_{2} , \\ with : \\ {A}_{1} = {S}_{1} - {S}_{2} \\ {A}_{2} = {S}_{1} + {S}_{2}\end{matrix}$$

The response A is related to the volume flow rate Q by A=T·Q.

The coefficient T reflects the dimensional and material features of the FDFM, as well as those of the implantation tube, the liquid metal and the dependence of the response on temperature and electrical excitation. There is one value of T for a temperature value associated with an electrical excitation, which is defined by its amplitude and its frequency. The field of the velocities in the implantation tube producing the flow rate Q measured by the FDFM according to the prior art contains velocities parallel to the central axis of the FDFM. Calibration is one-dimensional. The series of coefficients T is determined by parametric tests at a given temperature and excitation.

For the electromagnetic transducer 10 described above, it is possible to proceed in the same way as the calibration in [7], but by imposing a three-dimensional velocity field.

During tests at a fixed temperature and excitation, various velocity fields will be successively imposed with components in one or more directions: Ux, Uy, Uz.

During each test, the voltages e₁, e₂, e₃, e₄, e₅, e₆, of the coils 14.1 to 14.6, can be recorded. As many tests are carried out as there are terms Kᵢⱼ of the matrix K to be determined. In this way, a linear system of equations can be established and solved in order to compute each of the Kᵢⱼ terms of the matrix of three-dimensional components (Ux, Uy, Uz).

The tests will be parameterized in terms of temperature and excitation in order to also be able to determine the influence of the weighting terms kₜ and kₑ.

To supply electrical power to the primary coil 12 and to recover the currents in the receiver coils 14.1 to 14.6, the various connection wires that are required can be routed inside the cylindrical core 11.

An example of the integration of these wires is shown in FIG. 21: the electrical wires 15 are connected to the primary coil 12, and the electrical wires 16.1, 16.2, 16.3, 16.4 are connected to the receiver coils 14.1, 14.2, 14.3, 14.4, respectively.

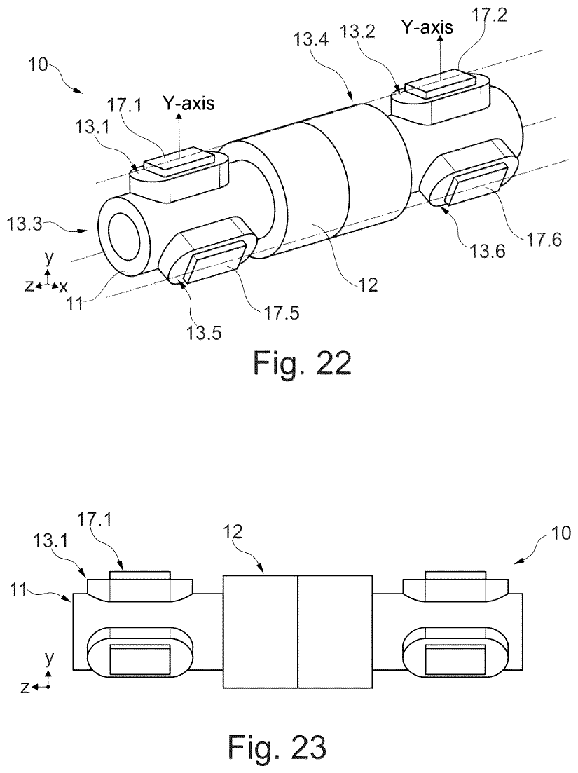

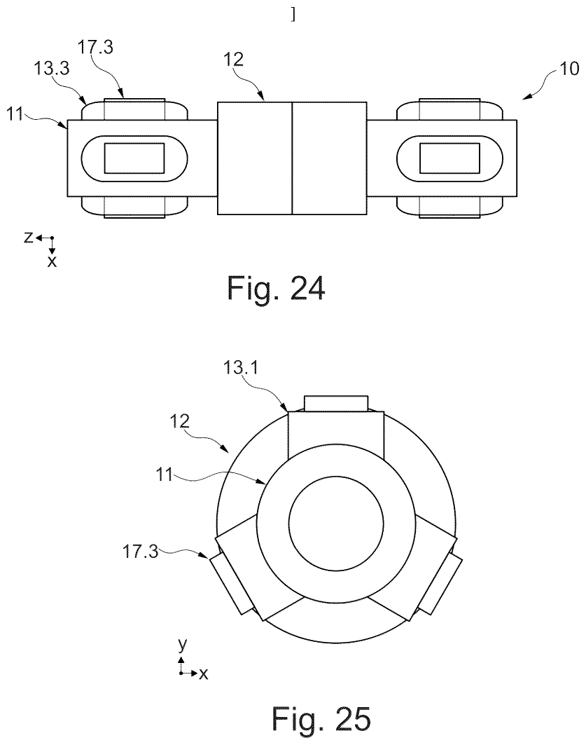

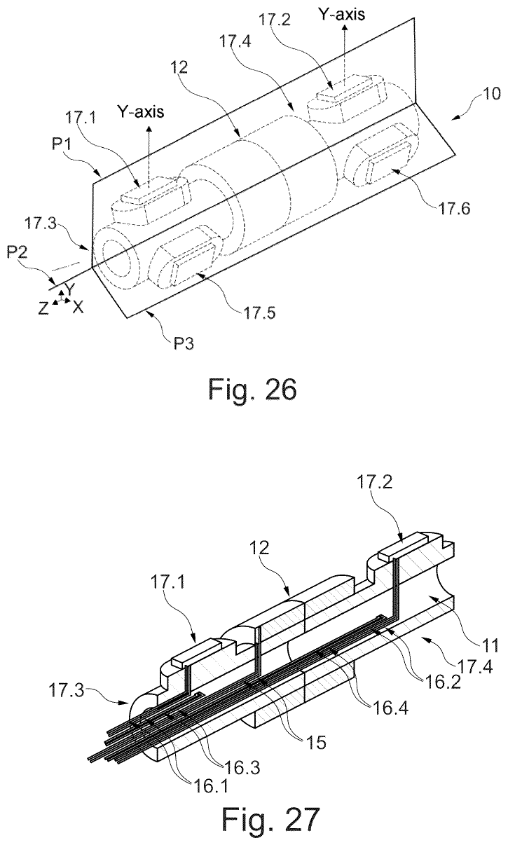

As illustrated in FIGS. 22 to 27, instead of the coils 14.1, 14.2, 14.3, 14.4, 14.5, 14.6, Hall effect sensors 17.1, 17.2, 17.3, 17.4, 17.5, 17.6 also can be provided with the same core 11 as described above in order to also produce an electromagnetic transducer 10 operating with alternating current. In this embodiment, a Hall effect sensor 17.1 to 17.6 is directly fixed to the flat surface delimited by a boss 13.1 to 13.6. The connection wires 15, 16.1 to 16.6 can be arranged as in the previous embodiment.

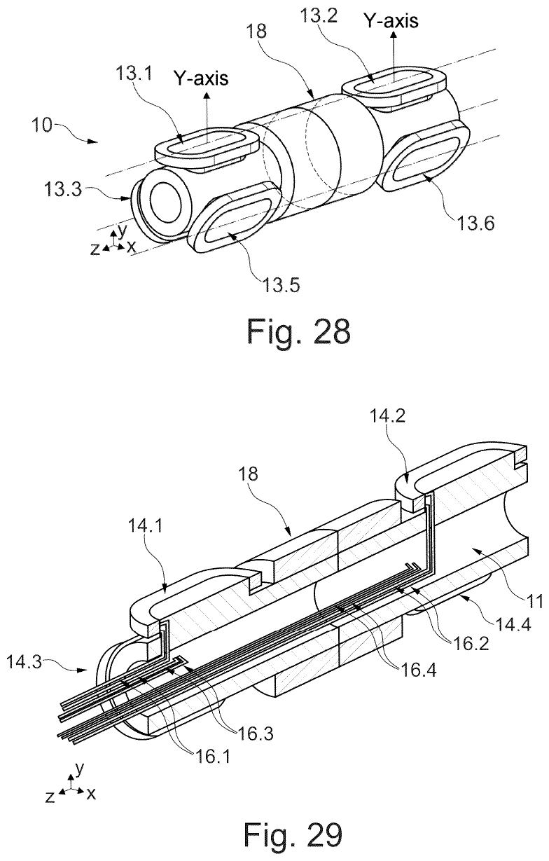

As illustrated in FIGS. 28 and 29, instead of a primary coil 12, a permanent magnet 18 with the same core 11 as described above can be provided in order to also produce an electromagnetic transducer 10 operating with direct current.

Other variants and improvements can be contemplated without departing from the scope of the invention.

### LIST OF CITED REFERENCES

[1]: https://www.hzdr.de/db/Cms?pOid=55433&pNid=226
[2]: https://ieeexplore.ieee.org/stamp/stamp.jsp?arnumber=9768530
[3]: https://www.degruyter.com/document/doi/10.1515/HTMP.2000.19.3-4.187/pdf
[4]: https://esfr-smart.eu/wp-content/uploads/2021/04/S₃₅_1_Sven_Eckert_ESFR_SMART_Measuring_Techniques.pd f
[5]: https://link.springer.com/content/pdf/10.1007/978-1-4020-4833-3_17.pdf?pdf=inline % 20link
[6]: https://iopscience.iop.org/article/10.1088/1757-899X/228/1/012023/pdf
[7]: https://iopscience.iop.org/article/10.1088/1757-899X/208/1/012031/pdf

1. An electromagnetic transducer intended to measure the three-dimensional velocity components of a flow of an electrically conductive fluid, comprising:
a cylindrical metal tube forming a core with high magnetic permeability, which tube extends along a central axis (Z), comprising a central portion and two end portions, on either side of the central portion, each comprising three bosses arranged at 120° relative to one another about the central axis (Z) and each delimiting a flat surface, parallel to the central axis (Z);
an electrical coil, called primary coil, wound around the central portion of the tube;
six electrical coils called receiver coils, each wound around one of the flat surfaces, or six Hall effect sensors, each arranged on one of the flat surfaces.

2. An electromagnetic transducer intended to measure the three-dimensional velocity components of a flow of an electrically conductive fluid, comprising:
a cylindrical metal tube forming a core with high magnetic permeability, which tube extends along a central axis (Z), comprising a central portion and two end portions, on either side of the central portion, each comprising three bosses, arranged at 120° relative to one another about the central axis (Z) and each delimiting a flat surface, parallel to the central axis (Z);
a permanent magnet arranged around the central portion of the tube;
six electrical coils called receiver coils, each wound around one of the flat surfaces, or six Hall effect sensors, each arranged on one of the flat surfaces.

3. The electromagnetic transducer as claimed claim 1, with each boss having a T-shape as a front view, orthogonal to the central axis (Z), with the head of the T being the flat surface.

4. A method of using of the electromagnetic transducer as claimed in claim 1 and measuring three-dimensional velocity components of a flow of an electrically conductive fluid, such as a liquid metal of a nuclear reactor.

5. The electromagnetic transducer as claimed in claim 2, with each boss having a T-shape as a front view, orthogonal to the central axis (Z), with the head of the T being the flat surface.

6. A method of using of the electromagnetic transducer as claimed in claim 2 and measuring three-dimensional velocity components of a flow of an electrically conductive fluid, such as a liquid metal of a nuclear reactor.
